(19) United States
(12) Patent Application Publication
(10) Pub. No.: US 2025/0130594 A1
(43) Pub. Date: Apr. 24, 2025

(54) Electronic System for Indoor Navigation Control of One or More Robots

(71) Applicant: Centro Di Ricerca, Sviluppo E Studi Superiori In Sardegna - CRS4 SRL Uninominale, Pula (CA) (IT)

(72) Inventors: Massimo Deriu, Capoterra (IT); Federico Bachis, Pula (IT); Marco Massa, Cagliari (IT)

(21) Appl. No.: 18/690,168

(22) PCT Filed: Sep. 29, 2022
(86) PCT No.: PCT/IB2022/059272

§ 371 Date: Mar. 7, 2024

(30) Foreign Application Priority Data
Sep. 29, 2021 (IT) 102021000024962

(51) Int. Cl. G05D 1/69; G05D 1/249; G05D 1/622; G05D 107/40; G06T 3/18; G06T 7/194; G06T 13/40

(52) U.S. Cl. CPC G05D 1/69; G05D 1/249; G05D 1/622; G06T 3/18; G06T 7/194; G06T 13/40; G05D 2107/40; G06T 2207/10016; G06T 2207/20132

(57) ABSTRACT

An electronic control system includes: a tracking system facing towards an indoor environment and adapted to co-operate with a tracker of each one of one or more robots, at least two optical-signal video cameras, in mutually orthogonal positions in the indoor environment, an electronic processing system including: a tracking manager, adapted to transform the indoor environment into a 3D space and adapted to receive signals from the tracking system, thereby determining the position and orientation of each one of the robots, an obstacle manager, adapted to process the optical signal received from the at least two video cameras, a movement manager adapted to receive information from the tracking manager and obstacle manager, and adapted to map the indoor environment to an equivalent virtual environment, and to produce signals controlling the direction and sense of motion of the one or more robots by communicating with the electronic processing system of the one or more robots.

### FIELD OF THE INVENTION

The present invention relates to an electronic navigation control system for controlling the navigation of one or more robots in an indoor environment, and more specifically to a system for autonomous navigation of one or more robots within an indoor environment based on the acquisition and processing of infrared signals (by means of room-scales and associated trackers) and optical signals (by means of video cameras for acquiring images of the area of movement).

### BACKGROUND ART

Within the scope of the present invention, the term robot refers to objects capable of making on-the-spot rotations and linear movements. The following objects fall under such definition:
tracked vehicles
wheeled robots
two-legged robots capable of on-the-spot rotations
air-cushion vehicles (hovercrafts)

In the field of electronic navigation control systems for controlling the navigation of one or more robots in an indoor environment, several technical problems need to be faced.

One technical problem relates to engineering, in an economical and rapid manner, an indoor environment with minimal infrastructural impact in order to allow a robot (or AGV, Automated/Automatic Guided Vehicle) to move autonomously within it. In indoor navigation systems requiring environment engineering (i.e. other than SLAM (Simultaneous Localization And Mapping) systems, wherein the environment is not known a priori and an orientation map is built after many exploration “attempts”, requiring a time-consuming path definition process), the site where the robot will have to move must be suitably equipped with optical, electric, magnetic, odometric or laser guides. This implies long installation times and high costs incurred for space preparation. Furthermore, once the paths have been defined, they will remain unchanged.

Another technical problem relates to the necessity of resuming the correct path after having encountered an obstacle. This difficulty is partly solved by IGV (Intelligent Guided Vehicle) systems, which however require additional time for instructing the robot about the available paths, which in this case as well are defined a priori and cannot be changed unless a new setup process is carried out. Moreover, IGV systems allow no changes in the environment, which must remain unchanged once its contours have been acquired.

The main goal is to give a robot the capability of moving autonomously within a “controlled” environment, avoiding obstacles and rapidly recalculating the optimum path to the target positions. Another goal is high environment configuration flexibility, permitting changes in the environment layout and target positions without calling for changes in the technical setup of the system.

Control systems are known which utilize, for robotic applications, room-scales and trackers in order to calculate the position and rotation of objects.
Title: “Quadrotor-Based Lighthouse Localization with Time-Synchronized Wireless Sensor Nodes and Bearing-Only Measurements”, Authors: Brian G. Kilberg, Felipe M. R. Campos, Craig B. Schindler and Kristofer S. J. Pister, Berkeley Sensor & Actuator Center, Department of Electrical Engineering and Computer Sciences, University of California, Berkeley, CA 94720, USA, 13 Jul. 2020.
Title: “Using VIVE Tracker to Detect the Trajectory of Mobile Robots”, Authors: Yong Wang, Peng Tian, Yu Zhou, Mao Mao Zhu, Qing Chen and Chang Zhang, EasyChair Preprint no. 6241, version 2, 20 Sep. 2021.

The following patents are also known which relate to solutions using robot tracking by means of room-scales:
KR100969873B1, CN109648570A, U.S. Pat. No. 7,196,487B2, CN108303677A.

Publications are also known which concern the use of video cameras for observing the area of movement and obtain information therefrom, followed by processing of the resulting images, such as:
Title: “A survey on moving object tracking using image processing”, Authors: S. R. Balaji Dr. S. Karthikeyan, Conference: 2017 11th International Conference on Intelligent Systems and Control (ISCO) At: Coimbatore, Tamilnadu, India.
Title: “REAL-TIME OBJECT DETECTION, TRACKING, AND 3D POSITIONING IN A MULTIPLE CAMERA SETUP”, Authors: Y. J. Lee, A. Yilmaz Dept. of Civil, Environmental and Geodetic Engineering, The Ohio State University, Columbus, Ohio, US, 11 Nov. 2013.

The solutions known in the art rely on information about the object, such as next movement prediction, dimensions, height, or on exact type identification based on a known list (person, animal, fruit, vehicle, etc.). Depth or stereoscopic cameras are used in order to compute the distance of the object: by using two or more of them, the position can be calculated.

Prior-art solutions suffer, however, from a number of problems and limitations, including the problem of engineering the environment to make it suitable for robot movement, which problem can be analyzed in the following terms:
Setup in terms of ease of installation of the equipment, costs and “visual pollution” due to markers or other graphic elements.
Ability to avoid obstacles
Path recalculation speed
Real-time destination changes

As far as the first point is concerned (setup in terms of ease of installation of the equipment, costs and “visual pollution” due to markers or other graphic elements), a wire-type guiding system is known which however has a great impact on the environment, since it is implemented by means of a wire laid just under the floor surface and carrying an electric signal at a given frequency. A magnet-based system is also known, which requires the installation of magnets in the floor. A great impact in terms of visual pollution derives from coloured-band systems implemented by means of paints or coloured adhesive tapes, or from odometric-guide or laser-triangulation systems, both needing the application of a number of reflectors on posts or objects along the robots' path. On the contrary, no environment setup or visual pollution problems affect IGV (Intelligent Guided Vehicle) systems, which utilize a video camera to recognize the contours of the environment so as to allow the robots to orientate themselves and move within it.

As far as the second point is concerned (ability to avoid obstacles), the above-listed solutions do not support this functionality. Conversely, IGV systems are technically able to avoid obstacles, but, since they move along predefined routes, they normally stop and wait for the obstacles to be removed.

As far as the (path recalculation speed), the above-listed solutions do not support this functionality. On the other hand, IGV systems require training to record a new map for setting new paths; they can avoid obstacles, but, since they move along predefined routes, they normally stop and wait for the obstacles to be removed.

Lastly, as concerns path recalculation speed and real-time destination changes, the above-listed solutions do not support this functionality. On the contrary, IGV systems can recalculate a path toward a destination.

### SUMMARY OF THE INVENTION

It is therefore the object of the present invention to provide an electronic navigation control system for controlling the navigation of one or more robots in an indoor environment, which can overcome all of the above-mentioned problems.

The solution of the present invention envisages the use of a system for autonomous navigation of a robot within an indoor environment which is based on the acquisition and processing of infrared signals (Tracker) and optical signals (Camera).

This is a hybrid, delocalized system that exploits sensors positioned in the environment and collectively organized and operated by software capable of processing information and returning paths and positions.

The above-described prior-art solutions are not based on such an approach. As concerns the processing of infrared signals, none of the currently known solutions uses, as the present invention does, a room-scale tracking system and associated trackers to find an object in a physical space and then represent it in simulated reality, i.e. in a 3D digital scene.

As concerns known setups with multiple cameras, their approach is different from that of the present invention. None of the solutions known in the art utilizes image warping to obtain an orthogonal view of the floor. This solution alone already provides a performance improvement in calculating the position of an object in a Cartesian space.

As described above, the problem of engineering the environment to make it suitable for robot movement can be analyzed in the following terms:
Setup in terms of ease of installation of the equipment, costs and “visual pollution” due to markers or other graphic elements
Ability to avoid obstacles
Path recalculation speed
Real-time destination changes

As far as the first point is concerned (setup in terms of ease of installation of the equipment, costs and “visual pollution” due to markers or other graphic elements), the solution of the present invention only needs a minimal procedure compared with wire-type or magnet-type guiding systems, which is executed by positioning room-scale stations at the corners of the area of movement and cameras mutually perpendicular to the latter. In terms of visual pollution, it has, unlike known wire-type, magnetic, odometric and laser systems, a null impact because it requires no markers (meaning, in a broad sense, codes, coloured tapes, paints or reflectors).

As concerns the ability to avoid obstacles and path recalculation speed, the solution of the present solution is, unlike prior-art solutions, highly capable.

The same is true as regards real-time destination changes, since the solution of the present invention is highly capable in comparison with prior-art solutions, standing out from them because it supports destination changes towards any point of the environment, even points that have not been defined beforehand. IGV systems can recalculate a path to a destination, but they do not support real-time destination changes unless the destination has already been set. In order to set a new destination, they need to be trained to record a new map for setting new paths.

The present invention relates to an electronic navigation control system for controlling the navigation of one or more robots in an indoor environment, each one of said robots comprising an electronic processing system, a drive system, microcontrollers, at least one tracker, said electronic control system being characterized in that it comprises:
a tracking system operating at infrared frequencies, positioned in and facing towards said indoor environment, adapted to co-operate with said tracker of each one of said robots,
at least two optical-signal video cameras, in mutually orthogonal positions in said indoor environment,
an electronic processing system comprising:
   a tracking manager, adapted to transform said indoor environment into a 3D space and adapted to receive signals from said tracking system, thereby determining the position and orientation of each one of said robots,
   an obstacle manager, adapted to process the optical signal received from said at least two video cameras and to identify or track obstacles that are present in said indoor environment,
   a movement manager adapted to receive information from said tracking manager and obstacle manager, and adapted to map said indoor environment to an equivalent virtual environment, and to produce signals controlling the direction and sense of motion of said one or more robots by communicating with said electronic processing system of said one or more robots.

The present invention also relates to a robot adapted for use in said electronic indoor navigation control system.

It is a particular object of the present invention to provide an electronic navigation control system for controlling the navigation of one or more robots in an indoor environment as set out in the claims, which are an integral part of the present description.

### BRIEF DESCRIPTION OF THE DRAWINGS

Further objects and advantages of the present invention will become apparent in light of the following detailed description of an exemplary embodiment (and variants thereof) provided herein with reference to the annexed drawings, which are only supplied by way of non-limiting example, wherein:

FIGS. 1 and 2 are diagrams showing a non-limiting example of the hardware of the electronic navigation control system for controlling the navigation of one or more robots in an indoor environment according to the invention;

FIG. 3 shows an exemplary construction of a robot controlled by the electronic control system of the invention;

FIG. 4 is a diagram representative of the physical space and virtual space for controlling a robot's movements;

FIGS. 5, 6 and 7 show ways of dividing a robot's area of movement into grids for implementing movement control by means of the electronic control system of the invention;

FIG. 8 shows an exemplary flow chart of the control system's software.

In the drawings, the same reference numerals and letters identify the same items or components.

### DETAILED DESCRIPTION OF SOME EMBODIMENTS

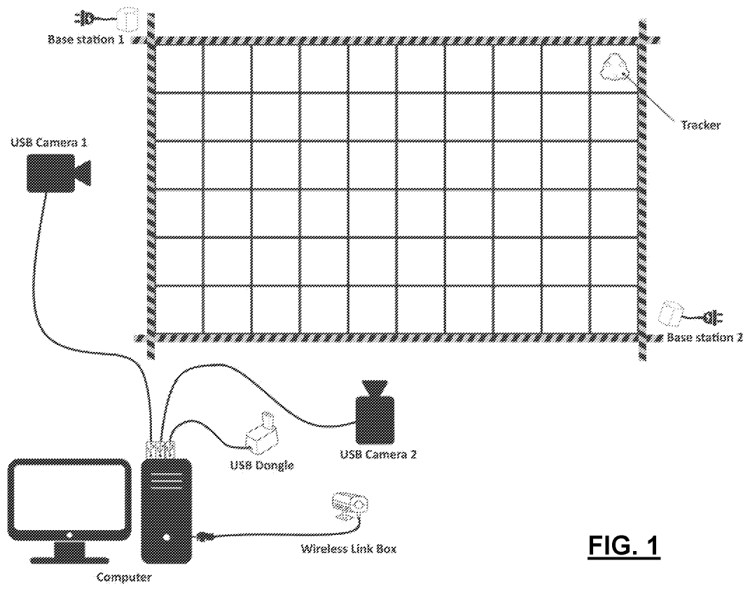

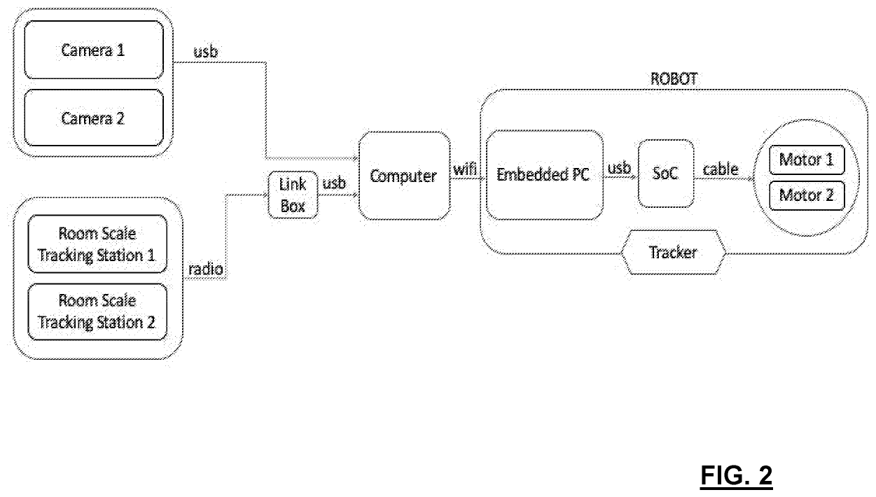

FIGS. 1 and 2 show an illustrative and non-limiting diagram of the hardware of the electronic navigation control system for controlling the navigation of one or more robots in an indoor environment.

FIG. 1 shows the indoor system; it comprises several components which are put in communication with one another through a computer. Such components include:
No. 2 HTC VIVE Base Stations, which constitute the room-scale tracking system and ensure, by means of an infrared system, punctual tracking of the tracker.
HTC VIVE Tracker, which, via photosensors, interprets the infrared signals received from the base stations and sends rotation and position to the USB Dongle.
USB Dongle, which constitutes the radio connection interface between the tracker and the computer.
Wireless Link Box, which constitutes the radio connection interface between the two base stations and the computer.
USB Cameras 1 and 2, which shoot the monitored area from two orthogonal angles and transfer the optical signals to the remote computer via USB.
Computer, which handles the computations and communications of all the systems connected thereto and control software developed in the UNITY environment.

The construction of the above-described components is within the grasp of a person skilled in the art.

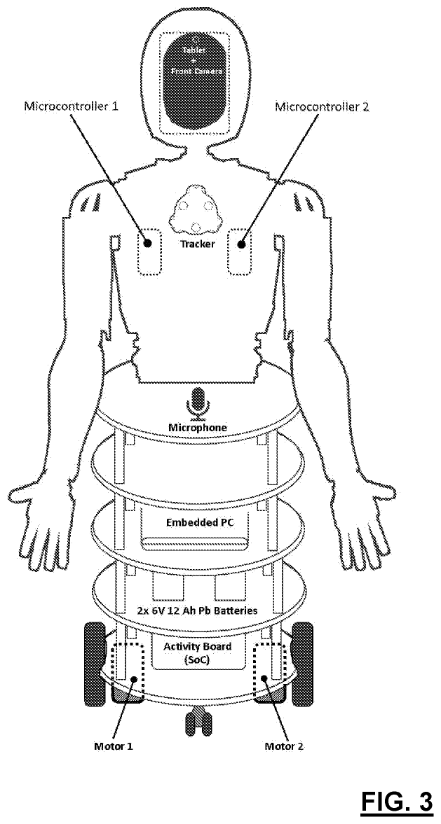

FIG. 2 shows in more detail the connections among the various systems of FIG. 1, as well as some robot's components (also shown in FIG. 3) that will be further described below, including:
Embedded PC, NVIDIA Jetson TX2 board, running ROS in communication with the computer via the Wi-Fi network and with the SoC (System on Chip) of the wheeled robot via USB.
SoC, an integrated board providing control over the motors connected to the drive wheels via a cable connection.
Motor 1 and Motor 2, 12 VDC electric motors transmitting motion to the wheels. They can be controlled individually by the SoC at different speeds.

The construction of the above-mentioned components is within the grasp of a person skilled in the art. In particular, the two motors are a non-limiting example of the robot's drive system. Other drive systems may nevertheless be implemented by those skilled in the art.

The area of movement must be an indoor environment, because the tracker's photoreceptors would be affected by interference from solar light, which would impair their reliability, since the sun is itself a great emitter of infrared rays. Therefore, the environment will provide optimum reliability in a closed room with no interference from direct solar light.

The cameras and the tracking stations are positioned in the environment, and the acquisition of infrared and optical signals allows the system to perform its function, i.e. guiding the robot towards the chosen destination, while avoiding any obstacles that may be encountered along the path.

The system can control one or more robotic units simultaneously. The robotic units may be heterogeneous as to hardware and software, the only compatibility requirement being the possibility of interfacing to the system via ROS (Robotic Operating System), which is per se known.

As far as the robot is concerned, FIG. 3 shows a non-limiting example of construction thereof. In addition to the items described above with reference to FIG. 2, it comprises, from a hardware viewpoint, an Embedded PC (e.g. implemented by means of an NVIDIA Jetson TX2 board), where ROS is executed in communication, via the Wi-Fi network, with the control software developed in the UNITY environment running on the computer, and, via a USB connection, with the firmware of the SoC (System on Chip) integrated board, which provides control over the electric motors connected to the drive wheels. Preferably, it also includes two microcontrollers, a front camera-equipped tablet, and at least one tracker.

The hardware implementation of such components of the robot is within the grasp of a person skilled in the art. The robot is of a known type, and the components highlighted herein are those entrusted with communicating with the control system. Said components are those which most directly interact with the software part of the control system.

From a software viewpoint, the system comprises the following main modules:

### Tracking Manager

This module is based on the room-scale tracking technology derived from the video game world, which transforms the environment into a 3D space where one can move freely. It is employed for tracking HMDs (Head Mounted Displays) and controllers simulating hand movements. Several implementations are known, whose principle of operation is the following: one or more emitters of infrared light (IR) are positioned in the environment, and receivers (display, controller, tracker) are positioned at various points on the surface of the object to be tracked, i.e. the robot. The “reading” of the IR signals by the various receivers determines the position and orientation of the object (i.e. the robot) in the space with sub-millimetre precision.

### Obstacle Manager

This module processes the images coming from two cameras positioned perpendicularly to the sides of the area of movement. The information obtained from the received data permits identifying and tracking any obstacles that are present in the area of movement of the robot.

### Movement Manager

This module processes in real time the information received from the two above-described systems in order to produce and manage the movement of the robot in the environment. Movement management is obtained by mapping the physical environment to an equivalent virtual environment.

### ROS Manager (Robotic Operating System).

This module is responsible for controlling the hardware of the robotic unit by acting upon the motors and the interface in order to command destination changes.

The Movement Manager communicates with the robot constantly to provide it with indications about the direction and sense of motion, the presence and position of any (stationary or moving) obstacles, and the coordinates of the destinations (hotspots).

In particular, the system includes:
combined use of two data sources (Tracking Manager+Obstacle Manager),
movement management algorithm,
dynamic obstacle recognition algorithm.

### Movement Management Algorithm.

In order to have the robot move correctly towards a hotspot, the Movement Manager processes and combines the technical data received from the other two modules (Tracking Manager and Obstacle Manager). Particularly due to the Tracking Manager module, an overlay is created between the physical environment and the virtual environment. This overlay is based on co-operation of the shapes of three robotic entities:
1. the physical robot (moving in the real environment)
2. the robot avatar (moving in the virtual environment)
3. the robot clone (moving in the virtual environment)

The physical environment is the real space in which movement of the physical robot occurs, whereas the virtual environment is the digital scene that constitutes a 3D representation of the physical environment. In the virtual environment the same dimensions, shapes and proportions found in the physical environment are kept, as regards walls and also any passages and pieces of furniture that may be present therein. The physical robot is the robotic entity that moves in the real environment, e.g. an anthropomorphic bust positioned on a motorized trolley.

The robot avatar is a 3D digital representation of the physical robot within the 3D scene, and has the same shapes and proportions.

In the physical robot a tracker is arranged which permits, by means of the Tracking Manager, identifying the exact position in space and creating a match with the robot avatar moving in the virtual space. When the command to reach a destination (hotspot) is issued, the robot clone will be generated in the virtual space. The robot clone is an exact copy of the robot avatar: like the latter, it has the same shapes and proportions as the physical robot, and its function is to move in advance with respect to the robot avatar, which moves synchronously with the physical robot. The optimal path is calculated by the robot clone, and any obstacles are identified by the Obstacle Manager module in real time.

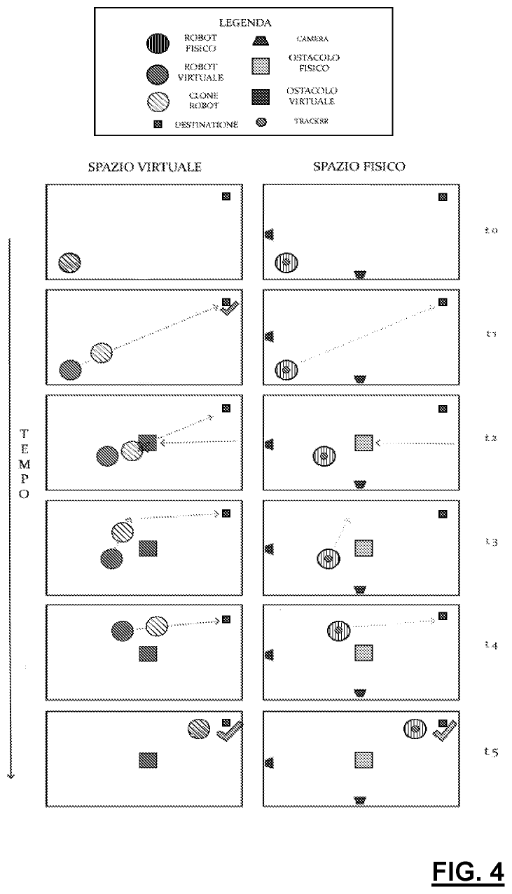

One example of such a movement is shown in FIG. 4.

The area of movement is divided into a grid, parameterized as a matrix. The path computed by the robot clone consists of a succession of elements of this matrix. When an obstacle appears along the path being followed by the robot avatar, the robot clone will restart from the last known position of the robot avatar, computing an alternative path. The anticipated movement of the robot clone with respect to the robot avatar allows the physical robot to avoid obstacles in real time and reach the destination with no collisions.

The algorithm is scalable, i.e. the number of robots that can move simultaneously in the physical environment can be increased.

### Dynamic Obstacle Recognition Algorithm.

This algorithm divides the area of movement into a grid, which, as aforesaid, is parameterized as a matrix. For interpreting the images coming from the two video cameras, the OpenCV library, which is per se known, is used.

In particular, two functionalities of the latter are exploited:
1. taking the distorted image from the perspective of the video camera and performing a warp operation that allows acquiring an orthographic image from above of the floor under examination,
2. executing a background subtraction on the warp image in order to detect the presence of new objects within the area under examination.

The algorithm performs this process simultaneously on the images of the two orthogonal video cameras, by comparing which it is possible to exclude any false positives in obstacle detection, as will be further described below.

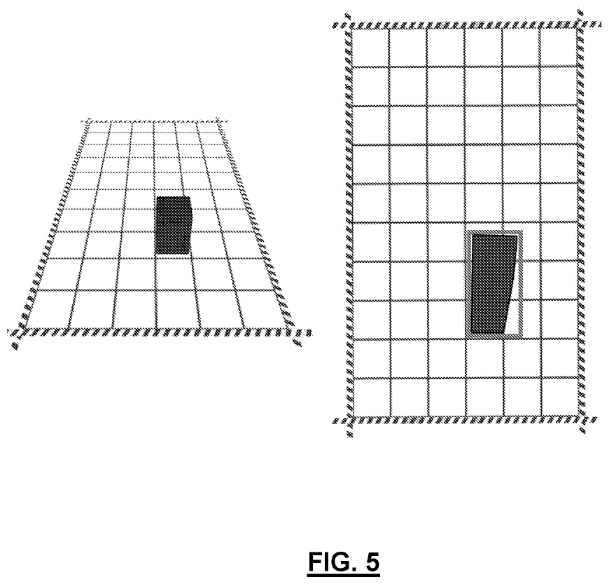

With reference to FIGS. 5, 6 and 7, the highlighted area shows the same obstacle elongated and distorted because of the perspective of the two cameras, which originate two orthogonal images.

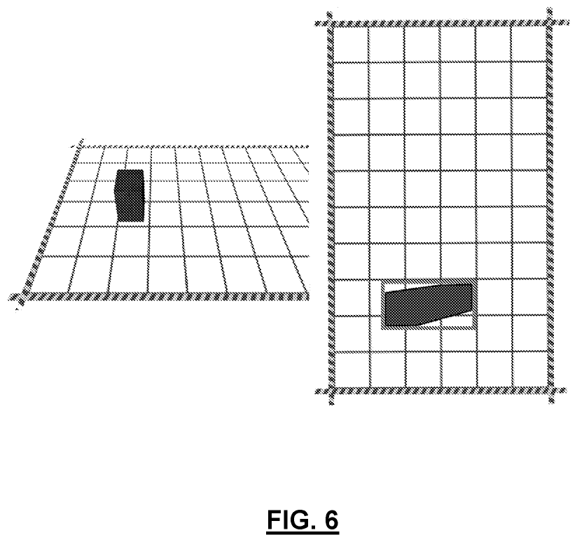

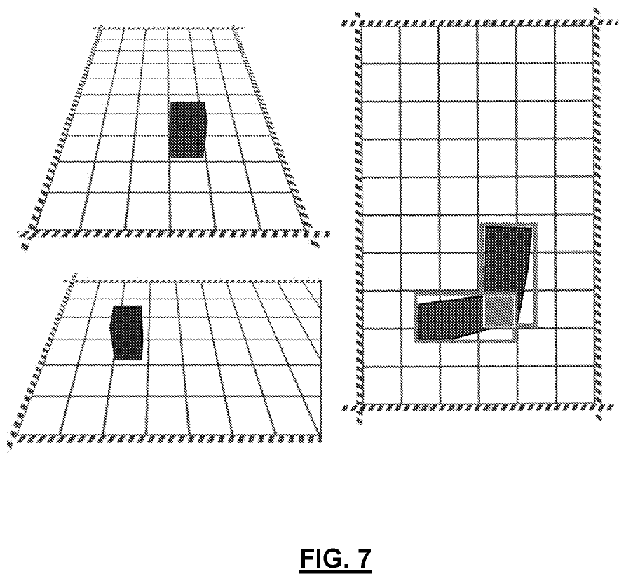

In FIGS. 5 and 6 a rectangle highlights the whole area that Open CV identifies as a new object from each one of the two cameras, while in FIG. 7 the overlay thereof highlights a square that is the actual size of the object, computed as approximately 30% (crop area) less than the rectangles' area.

The crop area is removed on the right or on the left of the object proportionally to its position:

$$CropLH = ( 1 - ( Xobj / width ) ) * CropPercent ; \\ CropRH = CropPercent - CropLH ;$$

The crop percentage is established during a calibration step and may vary depending on the height, the angle and the distance of the camera from the floor under examination.

The Obstacle Manager manages obstacles as elements of a matrix, for each position of the grid. These elements represent virtual obstacles that are normally “off”. When a notification indicating the presence of an obstacle is received from one of the two cameras, the corresponding flag will be activated on the obstacle. If both cameras signal the presence of an obstacle on the same element of the grid, both flags of that matrix element will be turned on, and consequently the Obstacle Manager will signal the presence of a physical obstacle to the Movement Manager.

Every single obstacle notes the last instant when each one of its flags has been turned on; a flag that has not been deactivated within a given period of time will automatically turn off, thereby deactivating the obstacle as well, if the latter is active.

In the example image, each camera notifies 3 occupied positions but, by cross-checking the two signals, the algorithm assesses that only one of them is reliable and that the others are due to perspective distortion.

The algorithm is scalable, i.e. additional cameras can be added for increased precision of detection, reducing the probability of false positives. It is also possible to calibrate the grid to improve the accuracy of the robot's movements and the precision in tracking the obstacles.

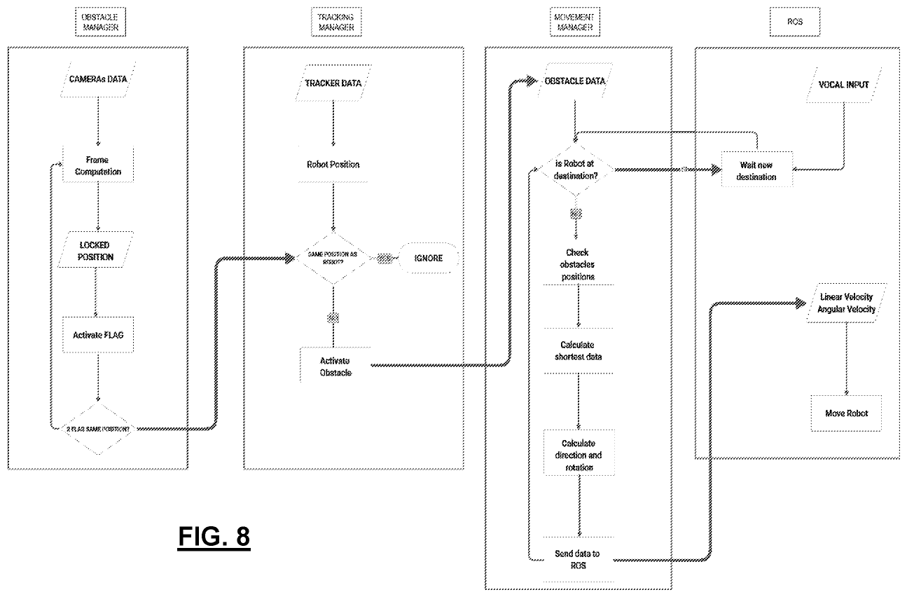

More in detail, the software modules for a non-limiting example of embodiment are described at logic level in the flow chart of FIG. 8.

### Obstacle Manager.

The Obstacle Manager is entrusted with identifying, by processing images supplied in real time by the cameras, probable dynamic obstacles appearing on the scene. This processing results in the production of a list of rectangles, which are then analyzed again in order to decide whether to associate them or not with an obstacle in the virtual scene.

During the setup phase, the algorithm creates a list of obstacles that cover the entire surface. It is possible to set a maximum number of obstacles that can be represented in the virtual scene. By increasing or decreasing this number one can adjust the obstacle detection sensitivity. The list of obstacles is represented in matrix form. One obstacle corresponds to each matrix element.

If an approach with many obstacles is chosen, the robot may pass closer to real obstacles (resulting in a higher risk of collisions in case of sudden movements), but it will also have more freedom of movement;

Conversely, with a smaller number of obstacles the robot's room for movement will be reduced, while however also reducing the risks of collisions.

During the runtime phase, each one of such obstacles can be dynamically activated or deactivated by the rectangle outputs produced by analyzing the cameras' frames. To do so, it is necessary to use a mapping function, which associates corresponding virtual obstacles with each image position.

Obstacles have a flag for each available camera. When a camera generates a rectangle, the latter will be converted into a list of indexes of the matrix of virtual obstacles. For each one of such obstacles, the flag corresponding to the camera that generated the rectangle will be activated.

The flag will then be automatically turned off half a second after the last call received from the activation function. If two or more flags are active simultaneously, the obstacle will be activated. When an active obstacle remains with one or zero flags, it will be immediately deactivated. It is important to note that the half a second delay in turning off the flags ensures effective synchronization of the information coming from the cameras, which send data asynchronously.

It is also possible to increase this tolerance to make the system less sensitive in notifying the presence of obstacles, de facto making those positions where an obstacle has been detected uncrossable for a longer time. A higher tolerance time decreases the risk that an obstacle not detected for an instant might release the passage too early or that a lag in the computer system might turn on the second flag too late.

### Tracking Manager.

The Tracking Manager takes care of positioning the robot correctly in the virtual representation (the 3D digital scene) and keeping the Movement Manager constantly informed about the robot's position.

When the exact position and rotation of the tracker have been received from the room-scale system, such data are used to position in the virtual scene a 3D model having the same dimensions as the real one. The Tracking Manager also compiles a list of the indexes of the obstacle matrix in the position where the robot is at, thus preventing the robot's position from being considered as an obstacle.

### Movement Manager.

The Movement Manager is that part which deals with all movement-related calculations.

To this end, it knows the entire surface whereon the robot may move, the obstacles' state provided by the Obstacle Manager, and the robot's position provided by the Tracking Manager.

Thanks to such information, it can compute at any time the shortest path from the robot's position to any other position over the entire surface.

To do so, it utilizes an A*-type algorithm, i.e. a per se known best-fit search algorithm applied to graphs, which identifies a path from a given starting node to a given target node, and uses a “heuristic estimate” that classifies each node by evaluating the best route passing through such node. In the Movement Manager, it is applied to the surface mesh, taking into account the obstacles that are active from time to time, so that the path is recalculated every time an obstacle appears or disappears.

In this manner, the robot will always follow the shortest route, even if the passage has just been cleared. Likewise, if the previous path is suddenly blocked by an obstacle, a new shortest path will be immediately calculated.

The A* algorithm returns a list of sequential positions, as points of the virtual space, that will have to be reached by the robot.

At this point, the Movement Manager will calculate the robot's current rotation as the angle between the tracker's position and a point positioned slightly ahead by a small offset.

In this way, these two points will always determine the angle towards which the robot is directed.

with:
(R.x,R.y) the position of the robot.
(F.x, F.y) the position of the “child” point ahead the current angle will be
currentAngle=Atan2 (R.x−F.x, R.y−F.y)*180/π

At the same time, the Movement Manager will compute the desired rotation necessary to reach the next point, as the angle between the tracker's position and the next point along the calculated path.

with:
(p.x,p.y) position x of the next path point
   the desired angle will be:
desiredAngle=Atan2 (p.x−R.x, p.y−R.y)*180/π

Lastly, the difference between the two rotations is computed in order to obtain a delta that will allow making a decision whether a rotation should occur or not, and optionally whether such rotation will have to be made to the right or to the left.

deltaAngle=currentAngle−desiredAngle;

If the difference is less than a degree of precision established beforehand, then a linear movement message will be sent to ROS.

Otherwise, from the difference between these two rotations it will be possible to understand if the robot will have to rotate to the right or to the left, sending as a consequence a (positive or negative) angular velocity to the robot's ROS central system (which considers the Movement Manager as one of its nodes).

The calculation is repeated several times per second on the remote computer, which thus operates as a controller for the movements made by the robot. In this way, the path will always be kept updated to the most favourable one starting from the current position of the robot.

If deltaAngle is smaller than a given number of degrees (e.g. 15), a forward movement message will be sent to the robot because, although such an accuracy level may seem to be too low to decide to move forwards, it will nonetheless be sufficient, due to such a quick calculation, to ensure that, if the movement is occurring in the wrong direction, the delta angle will grow enough to lead to a further rotation towards the next point. In this manner, the robot will describe a less sharp trajectory until it will perfectly adjust its trajectory.

The transmitted linear velocity is modulated according to the distance from the destination and from any obstacles; in fact, the robot will slow down when it arrives near the destination or an obstacle.

The present invention can advantageously be implemented by means of a computer program, which comprises coding means for implementing one or more steps of the method when said program is executed by a computer. It is understood, therefore, that the protection scope extends to said computer program and also to computer-readable means that comprise a recorded message, said computer-readable means comprising program coding means for implementing one or more steps of the method when said program is executed by a computer.

In the above-described non-limiting software implementation, the following known software languages have been used:
Unity 2019 LTS (development environment)
C#(programming language)
OpenCvForUnity, MathF, UnityEngine.*, System, ROS#, ValveVR (main libraries)

The above-described example of embodiment may be subject to variations without departing from the protection scope of the present invention, including all equivalent designs known to a person skilled in the art.

The elements and features shown in the various preferred embodiments may be combined together without however departing from the protection scope of the present invention.

From the above description, those skilled in the art will be able to produce the object of the invention without introducing any further construction details.

1. An electronic navigation control system for controlling the navigation of one or more robots in an indoor environment, each one of said robots comprising an electronic processing system, a drive system, microcontrollers, at least one tracker, said electronic control system comprising:
a tracking system operating at infrared frequencies, positioned in and facing towards said indoor environment, adapted to co-operate with said tracker of each one of said robots,
at least two optical-signal video cameras, in mutually orthogonal positions in said indoor environment,
an electronic processing system comprising:
a tracking manager, adapted to transform said indoor environment into a 3D space and adapted to receive signals from said tracking system, thereby determining the position and orientation of each one of said robots,
an obstacle manager, adapted to process the optical signal received from said at least two video cameras and to identify or track obstacles that are present in said indoor environment,
a movement manager adapted to receive information from said tracking manager and obstacle manager, and adapted to map said indoor environment to an equivalent virtual environment, and to produce signals controlling the direction and sense of motion of said one or more robots by communicating with said electronic processing system of said one or more robots.

2. The electronic navigation control system as in claim 1, wherein said movement manager performs said mapping of the indoor environment to an equivalent virtual environment by means of the following functions:
creating an overlay between the physical environment and the virtual environment, via co-operation of three robotic entities:
shape of said robot moving in said physical environment,
shape of a robot avatar and a robot clone of said robot, moving in a virtual environment equivalent to said physical environment,
said robot avatar being a digital representation of said robot in said 3D space, and being adapted to move synchronously with said robot,
said robot clone being a copy of said robot avatar, adapted to move in advance with respect to the robot avatar;
determining a dynamic recognition of obstacles in said physical environment as follows:
dividing said physical environment into a grid, parametrized as a matrix, and determining the path of the robot clone as a succession of elements of said matrix;
when an obstacle appears along the path of said robot avatar, restarting the robot clone from the last known position of the robot avatar, computing an alternative path;
said anticipated movement of the robot clone allowing the physical robot to avoid obstacles in real time and reach the destination with no collisions.

3. The electronic navigation control system as in claim 2, wherein said movement manager performs said dynamic recognition of obstacles by means of the following functions:
interpreting the images simultaneously received from each one of said video cameras,
taking a distorted and elongated image of an obstacle from the perspective of each one of the orthogonal video cameras and performing a warp operation that allows acquiring an orthographic image from above of the floor of said physical space,
making a comparison by background subtraction on the warp image of the video cameras in order to detect the presence of new objects within said physical space.

4. The electronic navigation control system as in claim 3, wherein said movement manager performs said comparison by background subtraction on the warp image of the video cameras by:
overlaying said orthogonally elongated distorted images produced by said two video cameras, thereby determining a common area;
determining, from said overlay, a real dimension of the obstacle as a crop area computed as a percentage of said common area.

5. A robot adapted for use with an electronic navigation control system in an indoor environment as in claim 1, and comprising an electronic processing system, a drive system, microcontrollers, at least one tracker, designed to co-operate with said electronic processing system.

6. A robot adapted for use with an electronic navigation control system in an indoor environment as in claim 2, and comprising an electronic processing system, a drive system, microcontrollers, at least one tracker, designed to co-operate with said electronic processing system.

7. A robot adapted for use with an electronic navigation control system in an indoor environment as in claim 3, and comprising an electronic processing system, a drive system, microcontrollers, at least one tracker, designed to co-operate with said electronic processing system.

8. A robot adapted for use with an electronic navigation control system in an indoor environment as in claim 4, and comprising an electronic processing system, a drive system, microcontrollers, at least one tracker, designed to co-operate with said electronic processing system.
